(19) United States
(12) Patent Application Publication
(10) Pub. No.: US 2006/0246901 A1
(43) Pub. Date: Nov. 2, 2006

(54) Supporting a decision by a mobile terminal whether to use an available access point

(75) Inventors: Tatikonda Venkata Lakshmi Narasinha Sivakumar, Tokyo (JP); Hongyuan Chen, Tokyo (JP)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/117,597

(22) Filed: Apr. 27, 2005

(51) Int. Cl. H04Q 7/20

(52) U.S. Cl. 455/436

(57) ABSTRACT

For supporting a decision by a mobile terminal whether to connect to an available access point for accessing a desired service, the mobile terminal receives from the access point reputation information on the access point and determines whether the reputation information makes a connection to the access point appropriate. A connection is initiated in case the connection is determined to be appropriate. Then, the mobile terminal rates the access point depending on a quality of a provided access service and transmits resulting rating information to a central control apparatus. The central control apparatus updates respective reputation information for various access points based on rating information received from mobile terminals, and provides the respective updated rating information to the concerned access point for transmission to mobile terminals.

### FIELD OF THE INVENTION

The invention relates to methods for supporting a decision by a mobile terminal whether to connect to an available access point for accessing a desired service and to software program products storing a corresponding software code. The invention relates equally to a mobile terminal, to an access point, to a central control apparatus and to a communication system.

### BACKGROUND OF THE INVENTION

A mobile terminal is usually able to access a communication network via one of various access points, in order to make use of a service provided by or via the communication network.

If the mobile terminal is equipped with a radio interface for a cellular communication network, the available access points may be base stations that are managed by a respective well known operator of a cellular communication network. In this case, the quality of the service that is provided by the access point is ensured by the operator.

Recently, however, many mobile terminals have been equipped in addition with secondary or even tertiary radio interfaces. These interfaces enable an access to a service via an access points of a wireless local access network (WLAN) that is provided by a possibly unknown operator. WLANs that could complement regular cellular networks could be based on the standards of the IEEE 802.11 family, on the Bluetooth™ standard, etc.

A mobile terminal might prefer in some cases to use a service via an access point of a WLAN instead of an access point of a cellular communication network. The access via the WLAN might be for instance more cost effective than via the cellular communication network. Further, the signal strength and thus the available service quality provided by an access point of a WLAN might be higher than the signal strength provided by an access point of a cellular communication network, for instance in indoor environments.

It is a problem with such WLAN access points that they may not be controlled by a single operator and thus provide an unmanaged or even hostile access service. If a mobile terminal decides about the use of a respective access point for a service access only based on capacity or quality related criteria, it can be a security threat if the service access is executed in an unfamiliar or hostile environment. For example, a denial of services attack can be easily performed by having an access point with a high transmission power, and advertising high quality service. When a mobile terminal requests an access, the access point can accept the request and then simply deny or drop the service after a connection has been established. In some cases the access point might even spy on a supported communication.

The problem is particularly severe in connection with service handovers. In a service handover, an ongoing service is handed over between different radio access networks. Some of the drivers for a service handover are capacity constraints over the radio access networks, quality considerations, or cost of the service. Traditionally, the handover mechanisms are based exclusively on a Received Signal Strength Indicator (RSSI), availability, cost, or other capacity or cost related criteria.

A handover is enabled in particular between different access points of a cellular communication, but equally between different access points of a WLAN, as described for instance in U.S. Pat. No. 6,587,680 B1 for IEEE 802.11 based network and for a High Performance radio Local Area Network (HIPERLAN). A service handover may even be enabled between different types of networks, for example between cellular networks and cost effective WLANs.

A denial of service attack by a target access point after a successful service handover results in a break down of the ongoing service.

Currently, the managed access networks offer authentication services that can be used to access only authenticated access points. This limits the access to possibly advantageous access services, though.

### SUMMARY OF THE INVENTION

It is an object of the invention to render the access of a mobile terminal to unfamiliar access points more secure.

An approach is proposed which involves an interaction between a mobile terminal, an access point and a central control apparatus.

With regard to the mobile terminal, a first method for supporting a decision by a mobile terminal whether to connect to an available access point for accessing a desired service is proposed. The method comprises receiving from the access point reputation information on the access point. The method further comprises determining whether the reputation information makes a connection to the access point appropriate. The method further comprises initiating a connection to the access point if a connection to the access point is determined to be appropriate. The method further comprises rating the access point depending on a quality of an access service provided by the access point. The method further comprises transmitting rating information resulting in the rating to a central control apparatus.

Moreover a mobile terminal is proposed, which comprises an evaluating component adapted to determine whether reputation information on the access point, received from an access point, makes a connection to the access point appropriate for accessing a desired service. The mobile terminal further comprises an access component adapted to initiate a connection to an access point, if a connection to the access point is determined to be appropriate by the evaluating component. The mobile terminal further comprises a rating component adapted to rate an access point depending on a quality of an access service provided by the access point and to cause a transmission of rating information resulting in the rating to a central control apparatus.

With regard to the mobile terminal, moreover a first software program product is proposed, in which a software code for supporting a decision by a mobile terminal whether to connect to an available access point for accessing a desired service is stored. When being executed in a processing unit of a mobile terminal, the software code receives from the access point reputation information on the access point. Further, the software code determines whether the reputation information makes a connection to the access point appropriate. Further, the software code initiates a connection to the access point if a connection to the access point is determined to be appropriate. Further, the software code rates the access point depending on a quality of an access service provided by the access point. Further, the software code causes a transmission of rating information resulting in the rating to a central control apparatus.

With regard to the access point, a second method for supporting a decision by a mobile terminal whether to connect to an available access point for accessing a desired service is proposed. The method comprises receiving from a central control apparatus reputation information on the access point. The method further comprises broadcasting the reputation information via a radio interface for enabling mobile terminals to determine whether a connection to the access point is appropriate. The method further comprises enabling a connection of a mobile terminal upon a request by the mobile terminal. The method further comprises providing a requested service to a connected mobile terminal.

Moreover an access point for a radio access network is proposed, which comprises a broadcasting component adapted to broadcast reputation information on the access point via a radio interface, for enabling mobile terminals to determine whether a connection to the access point is appropriate. The reputation information is provided by a central control apparatus. The access point further comprises an access component adapted to enable a connection of a mobile terminal upon a request by the mobile terminal.

With regard to the access point, moreover a wireless local access network comprising such an access point is proposed.

With regard to the access point, moreover a second software program product is proposed, in which a software code for supporting a decision by a mobile terminal whether to connect to an available access point for accessing a desired service is stored. When being executed in a processing unit of an access point, the software code receives reputation information on the access point provided by a central control apparatus. Further, the software code causes a broadcasting of this reputation information via a radio interface for enabling mobile terminals to determine whether a connection to the access point is appropriate for accessing a desired service.

With regard to the central control apparatus, a third method for supporting a decision by a mobile terminal whether to connect to an available access point for accessing a desired service is proposed. The method comprises receiving rating information for a particular access point from a mobile terminal, the rating information indicating a quality of an access service provided by the access point to the mobile terminal. The method further comprises updating reputation information for the access point based on the rating information for the access point. The method further comprises transmitting the updated reputation information to the access point.

Moreover, a central control apparatus is proposed, which comprises an updating component. The updating component is adapted to receive rating information for a particular access point from a mobile terminal, the rating information indicating a quality of an access service provided by the access point to the mobile terminal. The updating component is further adapted to update reputation information for this access point based on the rating information. The updating component is further adapted to cause a transmission of the updated reputation information to the access point.

With regard to the central control apparatus, moreover a third software program product is proposed, in which a software code for supporting a decision by a mobile terminal whether to connect to an available access point for accessing a desired service is stored. When being executed in a processing unit of a central control apparatus, the software code receives rating information for a particular access point from a mobile terminal, the rating information indicating a quality of an access service provided by the access point to the mobile terminal. Further, the software code updates reputation information for the access point based on the rating information. Further, the software code causes a transmission of the reputation information to the access point.

Finally, a communication system is proposed, which comprises the proposed mobile terminal, the proposed access point and the proposed central control apparatus.

The proposed software program products can be or comprise in particular any type of computer usable medium storing the software program code.

The invention proceeds from the idea that a reputation mechanism could be employed as a means for securing the access of a mobile terminal to access points. It is proposed that mobile terminals evaluate reputation information provided by an access point before requesting an access. Later on, the mobile terminal itself provides a rating about its experience with the access point to a central control apparatus. The central control apparatus updates respective reputation information for various access points based on ratings provided by various mobile terminals. Respectively updated reputation information is provided to the access point for which it has been established for transmission to mobile terminals in its coverage area.

It is an advantage of the invention that it allows minimizing impending security risks, when a mobile terminal considers establishing a connection to an access point, even in a hostile environment. The proposed system is resistant to denial of services attacks, as it is suited to isolate misbehaving access points. Thereby, it contributes to the expansion of trusted communications. The resulting ranking of access points in terms of the services they provide is moreover suited for streamlining the economic operation of the access points.

The invention can be employed for any connection of a mobile terminal to an access point. It is of particular advantage for a connection in the scope of a service handover. In this case, the proposed access point is a target access point for a service handover of the mobile terminal from another access point to which the mobile terminal is connected. Further, a connection to the target access point is initiated by the mobile terminal by requesting a service handover. In such a situation, the invention is suited to secure the handover process by preventing a handover to a target access point that might interrupt the service after the handover has been completed.

In one embodiment of the invention, the reputation information is a reputation metric, for instance a score, which is compared with a threshold value to eliminate access points with a low reputation from a conventional access decision. This approach introduces the requirement of bootstrapping new access points with initial reputation metrics.

In another embodiment of the invention, the mobile terminal combines the reputation information with other criteria for determining whether a connection to the access point is appropriate. The other criteria may be for example any conventional criteria, which are considered when deciding on a connection to an access point. Examples are information on the signal strength of signals received from the access point, availability, an advertised quality of service, advertised costs, etc. The combination can be calculated for example to be α times a reputation metric plus β times a traditional handover metric. Thus, the reputation information is not used as a binary qualification criterion but as a valuable input to the access criterion.

The proposed central control apparatus can be for instance a central server or another central authority.

In one embodiment of the invention, the central control apparatus comprises a memory, which is adapted to store information enabling a determination of respective reputation information for a plurality of access points. Such information may comprise for example previously computed or updated reputation information, previously received rating information and/or statistical information about previously received rating information. The updating component of the central control apparatus may then be adapted to update reputation information for an access point based on the received rating information and in addition on information for the access point stored in the memory.

In one embodiment of the invention, the central control apparatus authenticates a mobile terminal before updating reputation information based on rating information provided by the mobile terminal.

In one embodiment of the invention, the central control apparatus weights the rating information provided by a mobile terminal depending on a number of ratings that have been provided before by this mobile terminal for this access point. This allows eliminating biased or malicious ratings of an access point by a small group of mobile terminals.

In one embodiment of the invention, the updated reputation information is integrated by the central control apparatus into a tamper resistant certificate. The reputation information may then be transmitted by the by the central control apparatus to the access point by transmitting the tamper resistant certificate to the access point. This ensures that the access point can only broadcast correct reputation information.

The invention can be employed for connections to any type of access points, for example to access points of WLANs.

It may be used, for instance, for a handover of a voice conversation over a cellular network to a Voice over Internet Protocol (VoIP) conversation over local access networks, like IEEE 802.11x based networks and Bluetooth™ based networks. It may further be used, for instance, for a handover of a data connection from a General Packet Radio System (GPRS) services or another cellular packet service and to the Internet via public access networks. It may further be used for instance for any other service handover between a cellular transport and a public/local Internet transport.

The invention can be implemented as a protocol service similar to Internet based security protocols.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram of an exemplary communication system in which the invention can be implemented;

FIG. 2 is a schematic block diagram of a mobile station of the system of FIG. 1;

FIG. 3 is a schematic block diagram of an access point of the system of FIG. 1;

FIG. 4 is a schematic block diagram of a central server of the system of FIG. 1; and

FIG. 5 is a flow chart illustrating an operation in the system of FIG. 1.

### DETAILED DESCRIPTION OF THE INVENTION

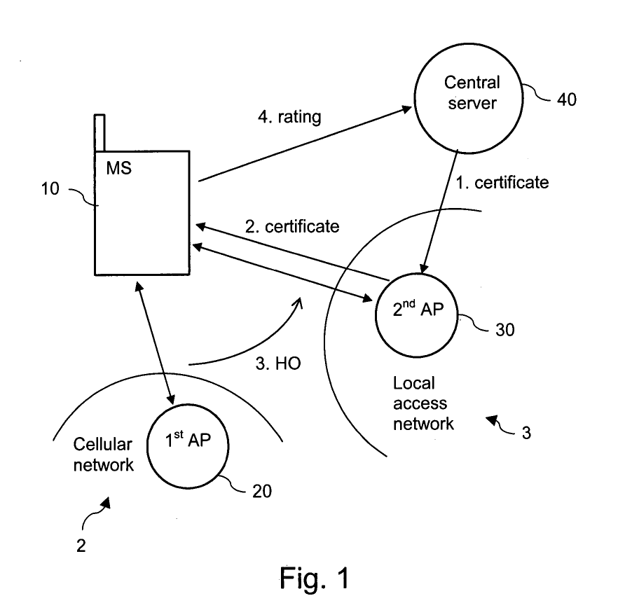

FIG. 1 is a schematic block diagram of an exemplary communication system according to the invention. In this system, a mobile terminal is enabled to decide based on a reputation of an access point whether or not to use this access point for accessing a service.

The communication system comprises a mobile station 10, a first access point (AP) 20, a second access point 30 and a central server 40.

The first access point 20 is a base station that belongs to a cellular communication network 2 or to any other kind of network, while the second access point 30 belongs to a Voice over IP local access network 3, for example to a Bluetooth™ network or an IEEE 802.11x network. The central server 40 may be, for example, a server that can communicate via the Internet with the cellular network 2 and with the local access network 3.

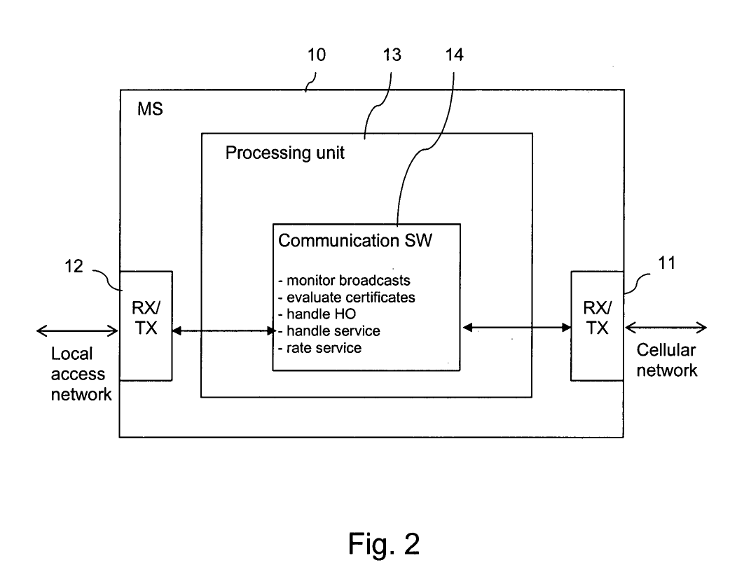

The mobile station 10, which is an embodiment of a mobile terminal according to the invention, is depicted in more detail in FIG. 2. FIG. 2 is a schematic block diagram showing selected elements of the mobile station 10 that are involved in a handover.

The mobile station 10 comprises a first radio transceiver 11 enabling an access to access points of the cellular network 2, a second radio transceiver 12 enabling an access to access points of the local access network 3 and a processing unit 13, which is connected to both transceivers 11, 12. The processing unit 13 is able to run various software codes. The implemented software codes include a communication software component 14.

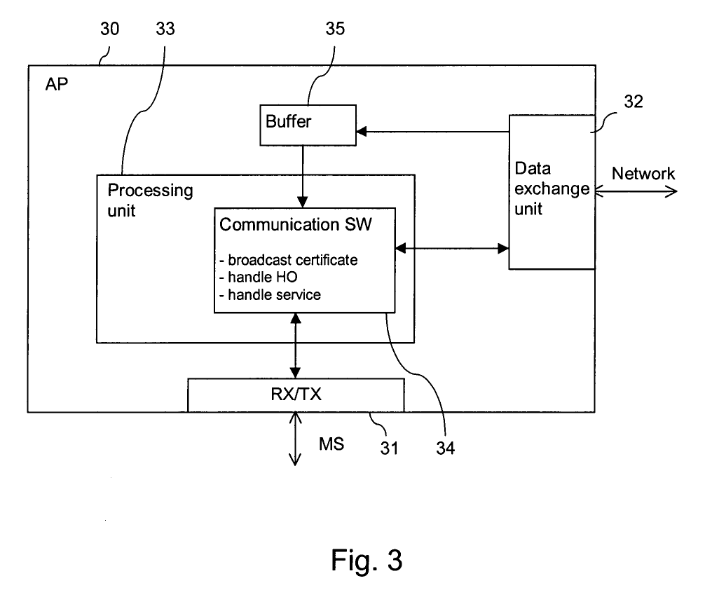

The second access point 30, which is an embodiment of an access point according to the invention, is depicted in more detail in FIG. 3. FIG. 3 is a schematic block diagram showing selected elements of the second access point 30 that are involved in a handover.

The second access point 30 comprises a radio transceiver 31 enabling a data exchange with mobile stations and a data exchange unit 32 providing an access via the local access network 3 to, by way of example, the Internet. Further, the second access point 30 comprises a processing unit 33, which is connected to both, the transceiver 31 and the data exchange unit 32. The processing unit 33 is able to run various software codes. The implemented software codes include a communication software component 34. The second access point 30 moreover comprises a buffer 35, which is connected on the one hand to the data exchange unit 32 and on the other hand to the processing unit 33.

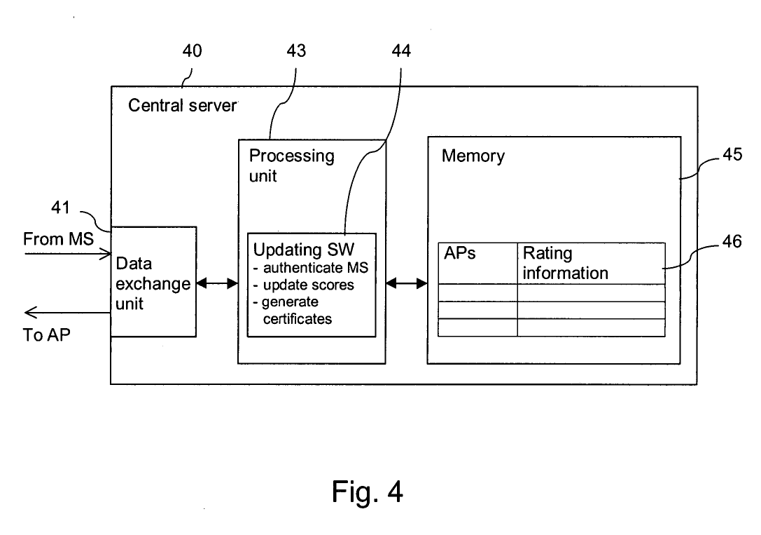

The central server 40, which is an embodiment of a central control apparatus according to the invention, is depicted in more detail in FIG. 4. FIG. 4 is a schematic block diagram showing selected elements of the central server 40 that are involved in a handover.

The central server 40 comprises a data exchange unit 41 providing an access to, for example, the Internet. Moreover, it comprises a memory 45 storing a database 46. The database 46 comprises rating information on various access points. The central server 40 further comprises a processing unit 43, which is connected to the data exchange unit 41 and to the memory 45. The processing unit 43 is able to run various software codes. The implemented software codes include an updating software component 44.

It is to be understood that all indicated connections in the mobile station 10, the second access point 20 and the central server 40 can be direct or indirect connections.

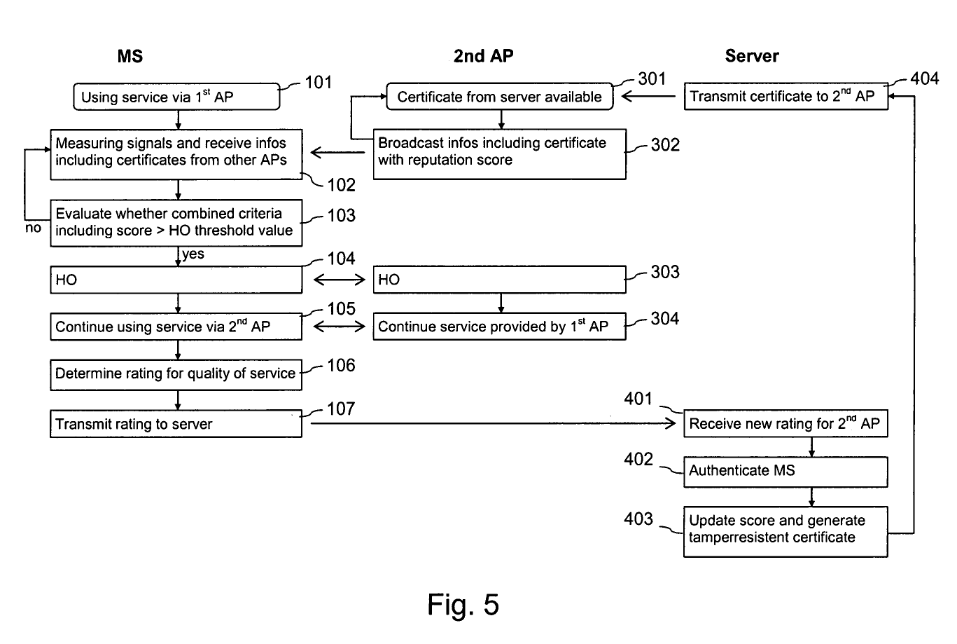

The operation in the communication system of FIG. 1 will now be described with reference to FIG. 5. FIG. 5 is a flow chart which illustrates on the left hand side operations by the mobile station 10, in the middle operations by the second access point 30 and on the right hand side operations by the central server 40.

The second access point 30 generally has a certificate stored in its buffer 35. (step 301) The certificate comprises a score which indicates the reputation of the second access point 30. The certificate is tamper resistant, that is, the second access point 30 is not able to replace an unfavorable score by a better score. The generation of the certificate will be described further below.

The communication component 34 of the second access point 30 causes a regular broadcast of information via the radio transceiver 31, thereby offering its services to mobile stations located in its coverage area. (step 302) The information includes the buffered certificate and arbitrary additional information, like current rates for accessing the local access network 3. This transmission is also indicated in FIG. 1 by an arrow labeled “2. certificate”.

At a starting point, the mobile station 10 uses a service via the cellular network 2. The mobile station 10 accesses the cellular network 2 via the first access point 20, which is thus a source access point. (step 101) Within the mobile station 10, the service is handled by the communication component 14.

During the ongoing service, the communication component 14 of the mobile station 10 checks regularly whether a service handover to an access point of a local access network 3 might be appropriate. This may be the case, for example, when the user of the mobile station 10 moves indoors and the strength of signals transmitted by the first access point 20 becomes too low for ensuring a high quality of service, or because the service is offered at a lower rate by a local access network 3.

For these checks, the communication component 14 monitors broadcast signals from any access point it receives at its present location, for example from the second access point 30. The second access point 30 is thus an optional target access point for a service handover. The communication component 14 performs on the one hand measurements on received broadcast signals and extracts on the other hand information included in received broadcast signals, at least an included certificate. (step 102)

From the certificate received from the second access point 30, the communication component 14 extracts the score for the second access point 30.

The communication component 14 then combines the score, the measurement results on the broadcast signals from the second access point 30 and possibly some further information provided by the second access point 30 with predetermined weighting factors for the different components to a single value. This value is compared with a predetermined threshold value. The predetermined weighting factors and the predetermined threshold value may be the same for all situations, but it may equally be selected flexibly, for example depending on the current type of service used by the mobile station 30. (step 103)

If the computed value does not exceed the threshold value, a handover to the second access point 30 is considered not to be appropriate. The mobile station 10 thus continues looking out for broadcast signals from other access points.

If the value exceeds the threshold value, in contrast, a handover to the second access point 30 is considered to be appropriate. In this case, the communication component 14 of the mobile station 10 initiates a handover from the first access point 20 to the second access point 30, which is carried out in a conventional manner. (steps 104, 303) This handover is also indicated in FIG. 1 by an arrow labeled “3. handover”.

Thereafter, the communication component 14 of the mobile station 10 continues using the service that was previously provided via the first access point 20 via the second access point 30. (steps 105, 304) For providing the service, the communication component 34 of the second access point 30 may, for instance, exchange data with the Internet via the data exchange unit 32.

When the service has been terminated, the communication component 14 of the mobile station 10 rates the service provided by the second access point 30. (step 106) The rating result may be for instance a rating value on a scale from ‘0’ to ‘10’, where a rating value of ‘0’ indicates no trust, for instance because the connection was dropped immediately after the handover, and where a rating value of ‘10’ indicates a complete trust.

The communication component 14 of the mobile station 10 then transmits the determined rating value to the central server 40, for instance via a new connection to the cellular network 2. (step 107) This transmission is also indicated in FIG. 1 by an arrow labeled “4. rating”.

The updating component 45 of the central server 40 receives the rating value from the mobile station 10. (step 401)

It checks thereupon the authenticity of the mobile station 10. (step 402)

If the check is positive, the updating component 45 updates the score for the second access point 30. To this end, it fetches from the database 46 for each possible rating value ‘0’ through ‘10’ the number of ratings that have been provided so far for the second access point 30.

Further, it fetches from the database 46 an indication how many ratings specifically the mobile station 10 has been provided in the past for the second access point 30.

The updating component 45 weights the current rating value provided by the mobile station 10 with a weighting factor that decreases with an increasing number of ratings that have been provided by the mobile station 10. That is, for a provided negative rating value, an increasingly less negative rating value is assumed, and for a positive rating value, an increasingly less positive rating value is assumed.

Then, the updating component 45 determines the average of all previous weighted rating values and the new, weighted rating value to obtain the updated score. Further, the updating component 45 increments the stored number of ratings with the rating value, which corresponds to the new, weighted rating value, by one. Equally, it increments the stored number of ratings provided by the mobile station 10 by one.

The updating component 45 inserts the determined score in a tamper resistant certificate. (step 403)

Finally, the certificate is transmitted, for example via the Internet, to the second access point 30. (step 404) This transmission is also indicated in FIG. 1 by an arrow labeled “1. certificate”.

The second access point 30 receives the certificate, stores it in the buffer 35 and uses it for future broadcast transmissions, which are indicated in FIG. 1 again by the arrow labeled “2. certificate”. (steps 301, 302)

It is to be understood that the functions of the communication software component 14 of the mobile station 10 may also be implemented in separate components, including for example a monitoring component, an evaluation component, a handover component, a service component and a rating component. It is further to be understood that the functions of the communication software component 34 of the second access point 20 may also be implemented in separate components, including for instance a broadcasting component, a handover component and a service component. It is further to be understood that the functions of the communication software component 44 of the central server 40 may also be implemented in separate components, comprising for example an authentication component, an updating component and a certificate generation component.

On the whole, it becomes apparent that the presented system makes handovers more reliable, because it enables a mobile station to avoid a handover to access points having a bad reputation according to the rating by a plurality of mobile stations.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for supporting a decision by a mobile terminal whether to connect to an available access point for accessing a desired service, said method comprising at said mobile terminal:
receiving from said access point reputation information on said access point;
determining whether said reputation information makes a connection to said access point appropriate;
if a connection to said access point is determined to be appropriate, initiating a connection to said access point;
rating said access point depending on a quality of an access service provided by said access point; and
transmitting rating information resulting in said rating to a central control apparatus.

2. The method according to claim 1, wherein said access point is a target access point for a service handover of said mobile terminal from another access point to which said mobile terminal is connected, and wherein a connection to said target access point is initiated by said mobile terminal by requesting a service handover.

3. The method according to claim 1, wherein said reputation information is a reputation metric and wherein determining whether a connection to said access point is appropriate comprises comparing said reputation metric with a threshold value to eliminate access points with a low reputation.

4. The method according to claim 1, wherein said mobile terminal combines said reputation information with other criteria for determining whether a connection to said access point is appropriate.

5. A mobile terminal comprising:
an evaluating component adapted to determine whether a reputation information on an access point, received from said access point, makes a connection to said access point appropriate for accessing a desired service;
an access component adapted to initiating a connection to an access point if a connection to said access point is determined to be appropriate by said evaluating component; and
a rating component adapted to rate an access point depending on a quality of an access service provided by said access point and to cause a transmission of rating information resulting in said rating to a central control apparatus.

6. A software program product in which a software code for supporting a decision by a mobile terminal whether to connect to an available access point for accessing a desired service is stored, said software code realizing the following steps when being executed in a processing unit of a mobile terminal:
receiving from said access point reputation information on said access point;
determining whether said reputation information makes a connection to said access point appropriate;
if a connection to said access point is determined to be appropriate, initiating a connection to said access point;
rating said access point depending on a quality of an access service provided by said access point; and
causing a transmission of rating information resulting in said rating to a central control apparatus.

7. A method for supporting a decision by a mobile terminal whether to connect to an available access point for accessing a desired service, said method comprising at said access point:
receiving from a central control apparatus reputation information on said access point;
broadcasting said reputation information via a radio interface for enabling mobile terminals to determine whether a connection to said access point is appropriate;
enabling a connection of a mobile terminal upon a request by said mobile terminal; and
providing a requested service to a connected mobile terminal.

8. The method according to claim 7, wherein said access point is a target access point for a service handover of said mobile terminal from another access point to which said mobile terminal is connected, and wherein a connection of said mobile terminal is enabled upon a handover request by said mobile terminal.

9. An access point for a radio access network comprising:
a broadcasting component adapted to broadcast reputation information on said access point via a radio interface for enabling mobile terminals to determine whether a connection to said access point is appropriate, wherein said reputation information is provided by a central control apparatus; and
an access component adapted to enable a connection of a mobile terminal upon a request by said mobile terminal.

10. An access point according to claim 9, wherein said access point is an access point for one of:
an IEEE 802.11 based radio access network;
a Bluetooth™ based radio access network; and
an Internet transport network.

11. A wireless local access network comprising an access point according to claim 9.

12. A software program product in which a software code for supporting a decision by a mobile terminal whether to connect to an available access point for accessing a desired service is stored, said software code realizing the following steps when being executed in a processing unit of an access point:
receiving reputation information on said access point, which reputation information is provided by a central control apparatus; and
causing a broadcasting of said reputation information via a radio interface for enabling mobile terminals to determine whether a connection to said access point is appropriate for accessing a desired service.

13. A method for supporting a decision by a mobile terminal whether to connect to an available access point for accessing a desired service, said method comprising at a central control apparatus:
receiving rating information for a particular access point from a mobile terminal, said rating information indicating a quality of an access service provided by said access point to said mobile terminal;
updating reputation information on said access point based on said rating information; and
transmitting said updated reputation information to said access point.

14. The method according to claim 13, wherein said central control apparatus authenticates a mobile terminal before updating reputation information based on rating information provided by said mobile terminal.

15. The method according to claim 13, wherein said central control apparatus weights said rating information depending on a number of ratings that have been provided before by said mobile terminal for said access point for updating said reputation information.

16. The method according to claim 13, wherein said reputation information is integrated into a tamper resistant certificate, and wherein said updated reputation information is transmitted to said access point by transmitting said tamper resistant certificate to said access point.

17. A central control apparatus comprising an updating component,
wherein said updating component is adapted to receive rating information for a particular access point from a mobile terminal, said rating information indicating a quality of an access service provided by said access point to said mobile terminal;
wherein said updating component is adapted to update reputation information for said access point based on said rating information; and
wherein said updating component is adapted to cause a transmission of said updated reputation information to said access point.

18. A central control apparatus according to claim 17, further comprising a memory adapted to store information enabling a determination of respective reputation information for a plurality of access points, wherein said updating component is adapted to update reputation information for an access point based in addition on information for said access point stored in said memory.

19. A software program product in which a software code for supporting a decision by a mobile terminal whether to connect to an available access point for accessing a desired service is stored, said software code realizing the following steps when being executed in a processing unit of a central control apparatus:
receiving rating information for a particular access point from a mobile terminal, said rating information indicating a quality of an access service provided by said access point to said mobile terminal;
updating reputation information for said access point based on said rating information; and
causing a transmission of said updated reputation information to said access point.

20. A communication system comprising a mobile terminal according to claim 5, an access point according to claim 9 and a network element according to claim 17.
